(19) United States
(12) Patent Application Publication
(10) Pub. No.: US 2010/0027707 A1
(43) Pub. Date: Feb. 4, 2010

(54) Transmitting Apparatus, Signal Processing Method and Communication System

(76) Inventors: Hiroaki TAKAHASHI, Kanagawa (JP); Ryou Sawai, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/511,427

(22) Filed: Jul. 29, 2009

(30) Foreign Application Priority Data
Jul. 29, 2008 (JP) P2008-195226

(51) Int. Cl. H04B 15/00; H04L 25/49

(52) U.S. Cl. 375/285; 375/296

(57) ABSTRACT

A transmitting apparatus is provided which includes a signal processing unit to perform signal processing of transmission data and an antenna to transmit transmission data processed by the signal processing unit, and the signal processing unit includes a digital filter to extract a signal component in a given frequency band and correct an aperture effect occurring during the signal processing.

### BACKGROUND OF THE INVENTION

1. Field of the Invention

The present invention relates to a transmitting apparatus, a signal processing method and a communication system.

2. Description of the Related Art

Wireless communication apparatus based on the IEEE (Institute of Electrical and Electronic Engineers) 802.11 standard are widely used today. The process of transmitting a radio signal in wireless communication apparatus is summarized as below:

(1) Digital modulation of transmission data

(2) Conversion from a frequency domain to a time domain

(3) Removal of unnecessary frequency components by a digital filter

(4) D/A conversion

(5) Up-conversion

(6) Transmission

In the D/A conversion in the above (4), for example, degradation of frequency characteristics called “aperture effect” occurs. Thus, a wireless communication apparatus has a structure for correcting the aperture effect in the digital phase or analog phase. The structure for correcting the aperture effect is disclosed in Japanese Unexamined Patent Publication No. 2002-290368, for example.

### SUMMARY OF THE INVENTION

However, there is a concern that the structure for correcting the aperture effect causes an increase in circuit size and power consumption. This concern is particularly significant in the OFDM (Orthogonal Frequency Division Multiplexing) scheme because it is necessary to make correction for all subcarriers.

In light of the above concern, it is desirable to provide a novel and improved transmitting apparatus, signal processing method and communication system that enable correction of the aperture effect and reduction of the circuit size and power consumption.

According to an embodiment of the present invention, there is provided a transmitting apparatus that includes a signal processing unit to perform signal processing of transmission data, and an antenna to transmit transmission data processed by the signal processing unit. Specifically, the signal processing unit includes a digital filter to extract a signal component in a given frequency band and correct an aperture effect occurring during the signal processing.

The signal processing unit may further include a digital modulation unit to convert the transmission data into a digital modulation signal, and a DA conversion unit to convert the digital modulation signal into an analog format, and the digital filter may correct an aperture effect occurring in the DA conversion unit. Further, the signal processing unit may further include a storage unit to store a synchronous training signal to be added to the transmission data, and a selection unit to select one of the digital modulation signal and the synchronous training signal, and one of the digital modulation signal and the synchronous training signal selected by the selection unit may be input to the digital filter.

According to another embodiment of the present invention, there is provided a signal processing method that includes the steps of performing signal processing of transmission data, and transmitting processed transmission data. Specifically, the step of performing signal processing extracts a signal component in a given frequency band and corrects an aperture effect occurring during the step of performing signal processing with use of a digital filter.

According to another embodiment of the present invention, there is provided a communication system that includes a transmitting apparatus including a signal processing unit to perform signal processing of transmission data and an antenna to transmit transmission data processed by the signal processing unit, and a receiving apparatus to receive the transmission data transmitted from the transmitting apparatus. Specifically, the signal processing unit of the transmitting apparatus includes a digital filter to extract a signal component in a given frequency band and correct an aperture effect occurring during the signal processing.

According to the embodiments of the present invention described above, it is possible to correct the aperture effect and reduce the circuit size and power consumption.

### BRIEF DESCRIPTION OF THE DRAWINGS

FIG. 1 is an explanatory view showing sampling data in a time domain.

FIG. 2 is an explanatory view showing frequency characteristics of sampling data.

FIG. 3 is an explanatory view showing a hold function of a DAC.

FIG. 4 is an explanatory view showing frequency characteristics of a signal having a rectangular waveform shown in FIG. 3.

FIG. 5 is a functional block diagram showing the structure of a wireless communication apparatus related to an embodiment.

FIG. 6 is an explanatory view showing frequency characteristics of a signal on which aperture correction is made by an aperture correction unit.

FIG. 7 is an explanatory view showing frequency characteristics of a transmission signal obtained based on aperture correction.

FIG. 8 is an explanatory view showing the structure of a wireless communication system and a wireless communication apparatus included in the wireless communication system according to an embodiment.

FIG. 9 is an explanatory view showing an example of the structure of a preamble.

FIG. 10 is an explanatory view showing the structure of a digital filter.

FIG. 11 is an explanatory view showing frequency characteristics of a digital filter of a wireless communication apparatus related to an embodiment.

FIG. 12 is an explanatory view showing frequency characteristics of a digital filter of a wireless communication apparatus according to an embodiment.

FIG. 13A is an explanatory view showing frequency characteristics of a transmission signal input to a digital filter.

FIG. 13B is an explanatory view showing frequency characteristics of a transmission signal output from a digital filter.

FIG. 13C is an explanatory view showing frequency characteristics of a transmission signal output from a DAC.

FIG. 13D is an explanatory view showing frequency characteristics of a transmission signal generated in an RF transmission processing unit.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

A preferred embodiment of the present invention will be described hereinafter in the following order:

(1) Overview of aperture effect

(2) Circumstances of development of the embodiment

(3) Structure of the wireless communication apparatus according to the embodiment

(4) Operation of the wireless communication apparatus according to the embodiment

(5) Summary

### (1) Overview of Aperture Effect

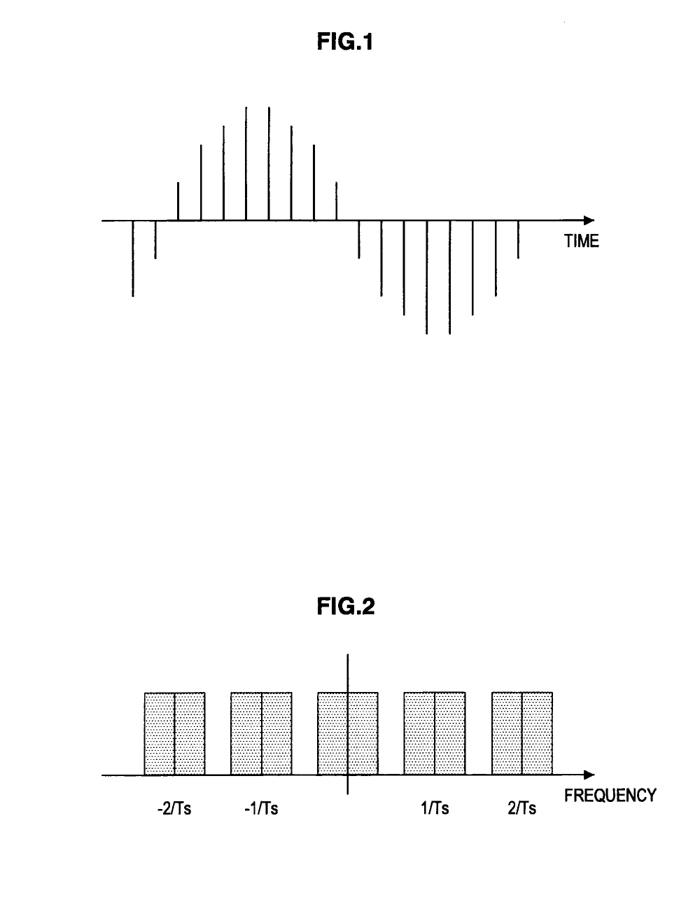

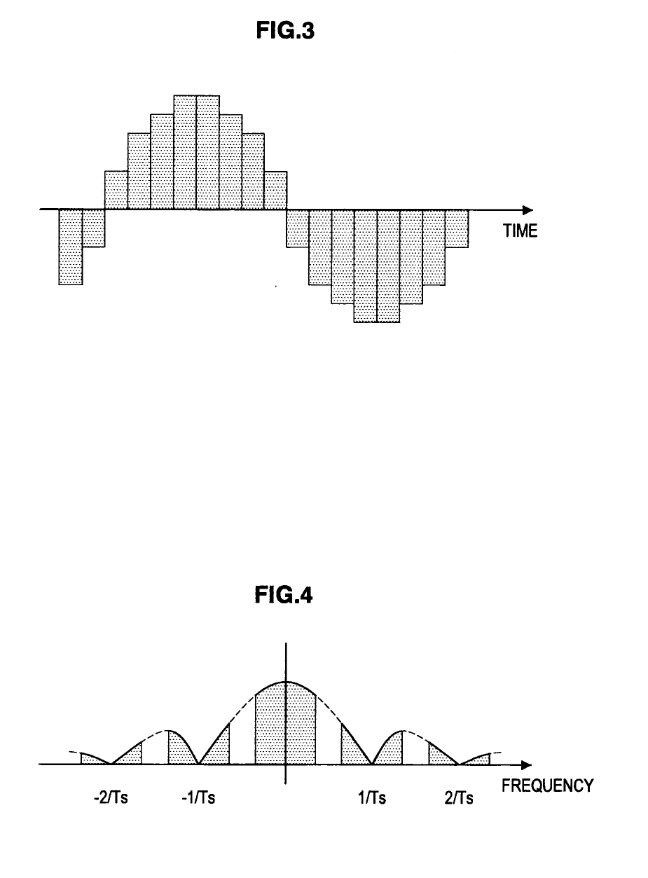

Before describing an embodiment of the present invention, the aperture effect that occurs during D/A conversion is described hereinafter with reference to FIGS. 1 to 4. FIG. 1 is an explanatory view showing sampling data in a time domain. FIG. 2 is an explanatory view showing frequency characteristics of sampling data. As shown in FIG. 2, sampling data is represented by a main lobe spectrum centered at 0 and side lobe spectrums centered at a sampling frequency (n/sampling period Ts where n is an integer) in a frequency domain. Further, as shown in FIG. 2, characteristics at each frequency in the main lobe spectrum are substantially uniform. The sampling data in the discrete impulse form is converted into a rectangular continuous-time signal shown in FIG. 3 by a DAC (Digital-to-Analog Converter).

FIG. 3 is an explanatory view showing a hold function of a DAC. As shown in FIG. 3, the DAC holds each input sampling data and outputs a signal in the time domain, which is like a set of rectangular waveforms. The frequency characteristics of a signal having such a rectangular waveform are described hereinafter with reference to FIG. 4. FIG. 4 is an explanatory view showing the frequency characteristics of the signal having the rectangular waveform shown in FIG. 3. As shown in FIG. 4, the signal having the rectangular waveform shown in FIG. 3 has frequency characteristics that the spectrum shown in FIG. 2 is multiplied by rectangular filter response (Sinc function). Comparing FIG. 4 with FIG. 2, in the signal having the rectangular waveform, the components at the outer sides (“shoulders”) of the main lobe spectrum and the side lobe spectrums are reduced in the frequency domain. Because a wireless communication apparatus includes a filter for filtering out the side lobe spectrums of the signal output from the DAC, reduction of the components of the side lobe spectrums does not affect the signal quality. On the other hand, reduction of the components at both sides of the main lobe spectrum directly adversely affects the signal quality. The drop at the shoulders of the main lobe spectrum is called the aperture effect. Although a case where the aperture effect occurs in the DAC is described above, the aperture effect may occur in any structure having the output hold function, for example.

### (2) Circumstances of Development of the Embodiment

As described above, it is known that the aperture effect occurs in the DAC. Thus, a wireless communication apparatus 70 related to an embodiment has a function for correcting the aperture effect occurring in the DAC. The wireless communication apparatus 70 related to the embodiment is described hereinafter.

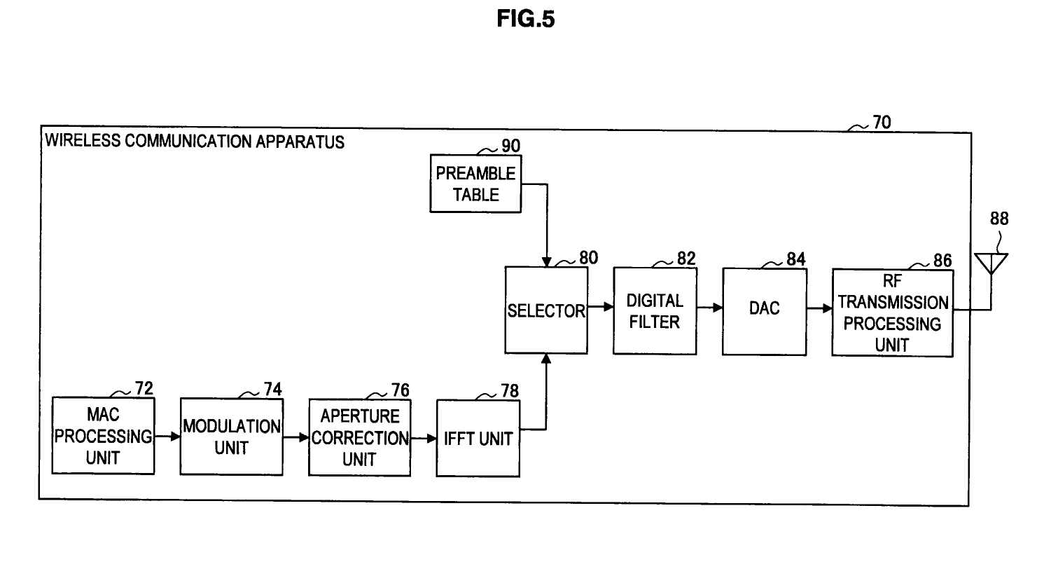

FIG. 5 is a functional block diagram showing the structure of the wireless communication apparatus 70 related to the embodiment. As shown in FIG. 5, the wireless communication apparatus 70 related to the embodiment includes a MAC processing unit 72, a modulation unit 74, an aperture correction unit 76, an IFFT unit 78, a selector 80, a digital filter 82, a DAC 84, an RF transmission processing unit 86, an antenna 88, and a preamble table 90.

The MAC (Medium Access Control) processing unit 72 performs access control in wireless communication. For example, the MAC processing unit 72 adds control information such as a MAC address of the own apparatus and a MAC address of a destination apparatus to transmission data and outputs it as a bit string. The modulation unit 74 performs signal processing such as modulation processing of the bit string that is output from the MAC processing unit 72. For example, the modulation unit 74 may perform modulation by any of modulation schemes such as BPSK (Binary Phase Shift Keying), QPSK, 16QAM (Quadrature Amplitude Modulation), 64QAM, 256QAM and 8PSK according to the conditions of a transmission line. The modulation unit 74 may perform modulation with respect to each bit allocated to each subcarrier in order to implement the OFDM (Orthogonal Frequency Division Multiplexing) scheme.

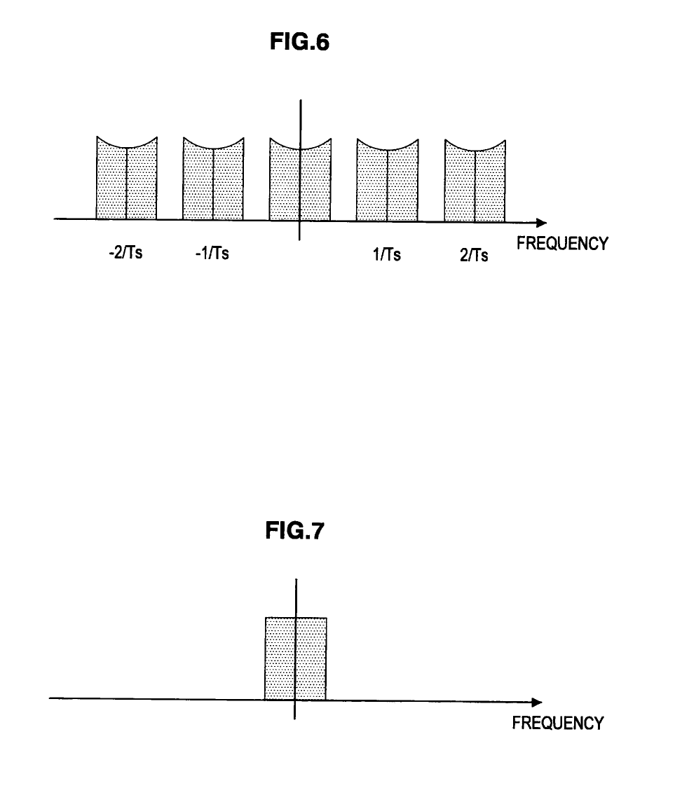

The aperture correction unit 76 performs aperture correction of a signal in the frequency domain that is obtained by the modulation unit 74. The aperture correction means reverse correction of the aperture effect that is expected to occur in the DAC 84, for example. The aperture correction is described later with reference to FIGS. 6 and 7. The IFFT (Inverse Fast Fourier Transform) unit 78 converts the signal in the frequency domain on which the aperture correction is made by the aperture correction unit 76 into a transmission signal in the time domain (OFDM signal) by inverse fast Fourier transform. The digital filter 82 eliminates unnecessary frequency components from the transmission signal in the time domain that is obtained in the IFFT unit 78. A guard interval may be added to the transmission signal in the time domain.

The DAC (Digital-to-Analog Conversion unit) 84 converts the transmission signal that is output from the digital filter 82 from a digital format to an analog format. Then, the RF transmission processing unit 86 converts (up-converts) the analog transmission signal into a high-frequency signal (e.g. 5 GHz band) by IQ modulation, for example. Then, the antenna 88 transmits the high-frequency signal that is output from the RF transmission processing unit 86 as a radio signal.

The function of the aperture correction unit 76 is described specifically with reference to FIG. 6 and FIG. 7. FIG. 6 is an explanatory view showing frequency characteristics of a signal on which aperture correction is made by the aperture correction unit 76. As shown in FIG. 6, the aperture correction unit 76 increases the components at the outer sides of the main lobe spectrum and the side lobe spectrums of the signal in the frequency domain that is obtained by the modulation unit 74. In other words, the aperture correction unit 76 performs reverse correction of the aperture effect that decreases the components at the outer sides. The transmission signal on which the aperture correction is made finally has the frequency characteristics shown in FIG. 7, after the aperture effect is exerted by the DAC 84 and the side lobe spectrums are removed by the RF transmission processing unit 86.

FIG. 7 is an explanatory view showing frequency characteristics of the transmission signal that is obtained based on the aperture correction. As shown in FIG. 7, as a result of the aperture correction by the aperture correction unit 76, the transmission signal having characteristics that the components at the shoulders of the main lobe spectrum are not reduced can be obtained. Further, as shown in FIG. 5, the wireless communication apparatus 70 related to the embodiment includes the selector 80 and the preamble table 90. The preamble table 90 stores a preamble (synchronous training signal) of a known fixed pattern to be added to the transmission data. The selector 80 connects the preamble table 90 to the digital filter 82 during a preamble transmission period and connects the IFFT unit 78 to the digital filter 82 during a data transmission period.

Although the aperture correction has been made by the aperture correction unit 76 on the transmission signal that is output from the IFFT unit 78, the aperture correction by the aperture correction unit 76 is not made on the preamble. Therefore, it is necessary to store the preamble in the state the aperture correction has been made in the preamble table 90.

However, because the aperture effect occurring in the wireless communication apparatus 70 changes when the specifications of the DAC 84 or the like change, it is necessary to recalculate and update the preamble to be stored in the preamble table 90 according to the aperture effect after the change. Further, there is a concern that the aperture correction unit 76 causes an increase in the circuit size and power consumption of the wireless communication apparatus 70. This concern is particularly significant in the OFDM (Orthogonal Frequency Division Multiplexing) scheme because it is necessary to perform correction for all subcarriers.

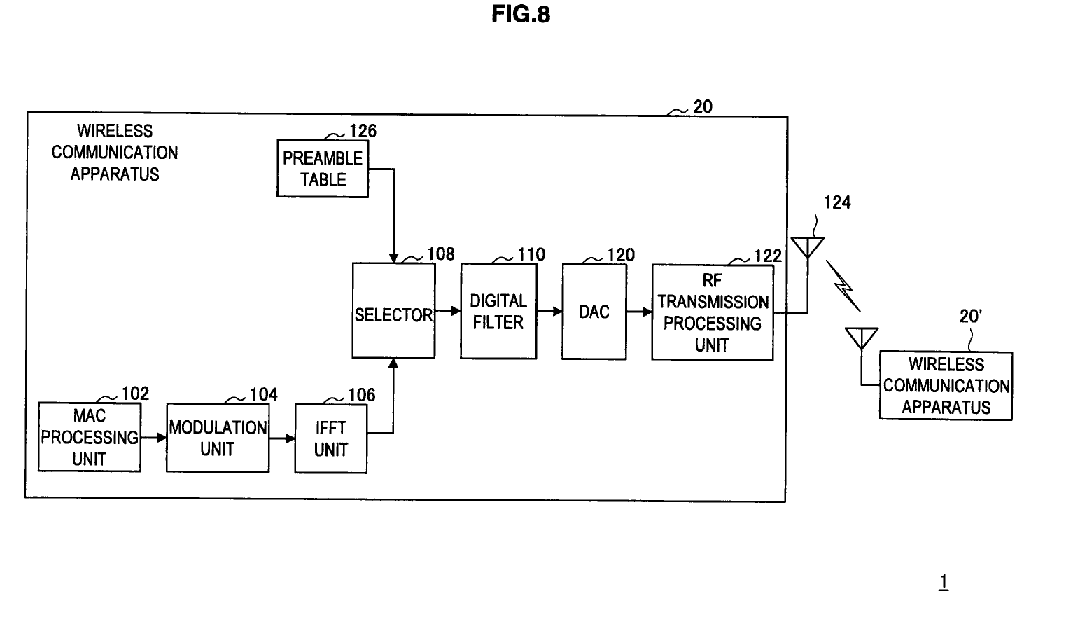

Given such circumstances, a wireless communication apparatus 20 according to an embodiment of the present invention has been invented. According to the wireless communication apparatus 20 of this embodiment, it is possible to correct the aperture effect with a smaller circuit size and lower power consumption. The wireless communication apparatus 20 is described hereinafter with reference to FIGS. 8 to 13.

### (3) Structure of the Wireless Communication Apparatus According to the Embodiment

FIG. 8 is an explanatory view showing the structure of a wireless communication system 1 and the wireless communication apparatus 20 included in the wireless communication system 1 according to the embodiment. Referring to FIG. 8, the wireless communication system 1 according to the embodiment includes a plurality of wireless communication apparatus 20 and 20′. Although an example where the wireless communication apparatus 20 functions as a transmitting apparatus and the wireless communication apparatus 20′ functions as a receiving apparatus is described below, the wireless communication apparatus 20 and 20′ have both the function as a transmitting apparatus and the function as a receiving apparatus. The wireless communication apparatus 20 and 20′ may be an information processing apparatus such as a PC (Personal Computer), a home video processing device (e.g. a DVD recorder, a videocassette recorder etc.), a cellular phone, a PHS (Personal Handyphone System), a portable sound playback device, a portable video processing device, a PDA (Personal Digital Assistants), a home game device, a portable game device or an electrical household appliance, for example. Further, although FIG. 8 shows an example where the wireless communication apparatus 20 and 20′ have one antenna 124 (one branch) for convenience of description, the wireless communication apparatus 20 and 20′ may have a plurality of antennas 124 (a plurality of branches).

As shown in FIG. 8, the wireless communication apparatus 20 according to the embodiment includes, as a signal processing unit, a MAC processing unit 102, a modulation unit 104, an IFFT unit 106, a selector 108, a digital filter 110, a DAC 120, an RF transmission processing unit 122, an antenna 124 and a preamble table 126.

The MAC (Medium Access Control) processing unit 102 performs access control in wireless communication. For example, the MAC processing unit 102 adds control information such as a MAC address of the own apparatus and a MAC address of a destination apparatus to transmission data and outputs it as a bit string. The modulation unit (digital modulation unit) 104 performs signal processing such as MIMO transmission processing and modulation processing of the bit string that is output from the MAC processing unit 102. The MIMO transmission processing is allocation of the bit string to each branch, beam forming or the like, for example. Further, the modulation unit 104 may perform modulation by any of modulation schemes such as BPSK, QPSK, 16QAM, 64QAM, 256QAM and 8PSK according to the conditions of a transmission line. The modulation unit 104 may perform modulation with respect to each bit allocated to each subcarrier in order to implement the OFDM scheme.

The IFFT unit (digital modulation unit) 106 converts a signal in the frequency domain that is obtained by the modulation unit 104 into a transmission signal in the time domain (OFDM signal) by inverse fast Fourier transform. The digital filter 110 eliminates unnecessary frequency components from the transmission signal in the time domain that is obtained in the IFFT unit 106. A guard interval may be added to the transmission signal in the time domain. The DAC (Digital-to-Analog Conversion unit) 120 converts the transmission signal that is output from the digital filter 110 from a digital format to an analog format. Then, the RF transmission processing unit 122 converts (up-converts) the analog transmission signal into a high-frequency signal (e.g. 5 GHz band) by IQ modulation, for example. Then, the antenna 124 transmits the high-frequency signal that is output from the RF transmission processing unit 122 as a radio signal.

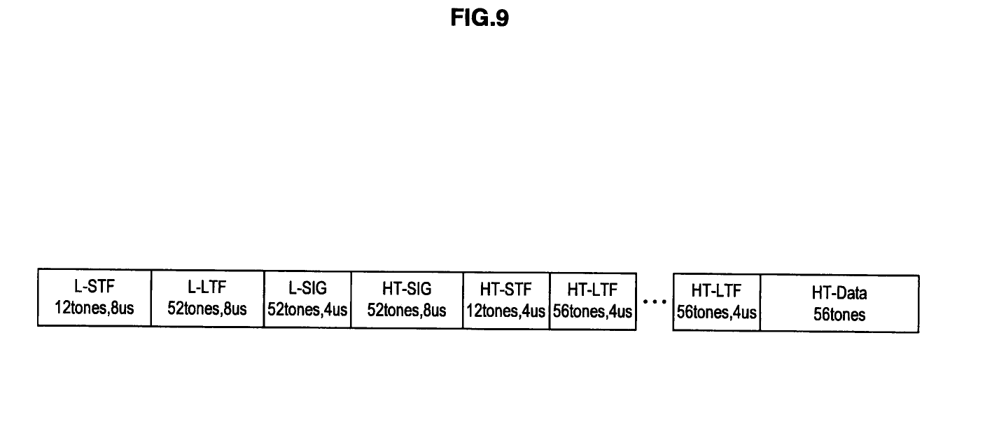

The preamble table 126 has a function as a storage unit that stores a preamble (synchronous training signal) to be added to transmission data. An example of the structure of the preamble is described hereinafter with reference to FIG. 9.

FIG. 9 is an explanatory view showing an example of the structure of the preamble. As shown in FIG. 9, the preamble contains L-STF (Short Training Field), L-LTF (Long Training Field), L-SIG, HT-SIG, HT-STF and HT-LTF, and transmission data (HT-Data) is added after that. In the L-STF, a signal pattern with a period of 0.8 μs is repeated ten times, and the wireless communication apparatus 20′ at the receiving end detects reception of a radio signal based on the L-STF. In the L-LTF, after the latter half (1.6 μs) of a signal pattern with a period of 3.2 μs, the signal pattern is repeated twice. Thus, the latter half of the signal pattern added at the head of the L-LTF serves as a guard interval. The L-SIG and the HT-SIG contain information such as a transmission rate and a modulation scheme of the transmission data that is contained in the frame. The HT-LTF is used to estimate a channel for each branch in the wireless communication apparatus 20′ at the receiving end.

The preamble table 126 stores the time waveform of the L-STF and the L-LTF. Thus, when a transmission request is made, the selector 108 (selection unit) first makes a connection to the preamble table 126 and thereby selects the L-STF and the L-LTF. After that, the selector 108 makes a connection to the IFFT unit 106 and thereby selects the L-SIG, the HT-SIG, the HT-STF, the HT-LTF and the transmission data (HT-Data) that are output via the IFFT unit 106. The signal selected by the selector 108 is output to the digital filter 110.

The digital filter 110 has an aperture correction function in addition to a function of filtering out unnecessary frequency components, as described later. Therefore, it is not necessary that the aperture correction is made on the L-STF and the L-LTF stored in the preamble table 126. It is thus not necessary to update the preamble table 126 even if the degree of aperture effect changes due to a change in specifications of the DAC 120 or the like, unlike the wireless communication apparatus 70 related to the embodiment described in the above (2) Circumstances of development of the embodiment. The wireless communication apparatus 20 according to the embodiment can thereby improve the flexibility of a change in specifications of the DAC 120 or the like.

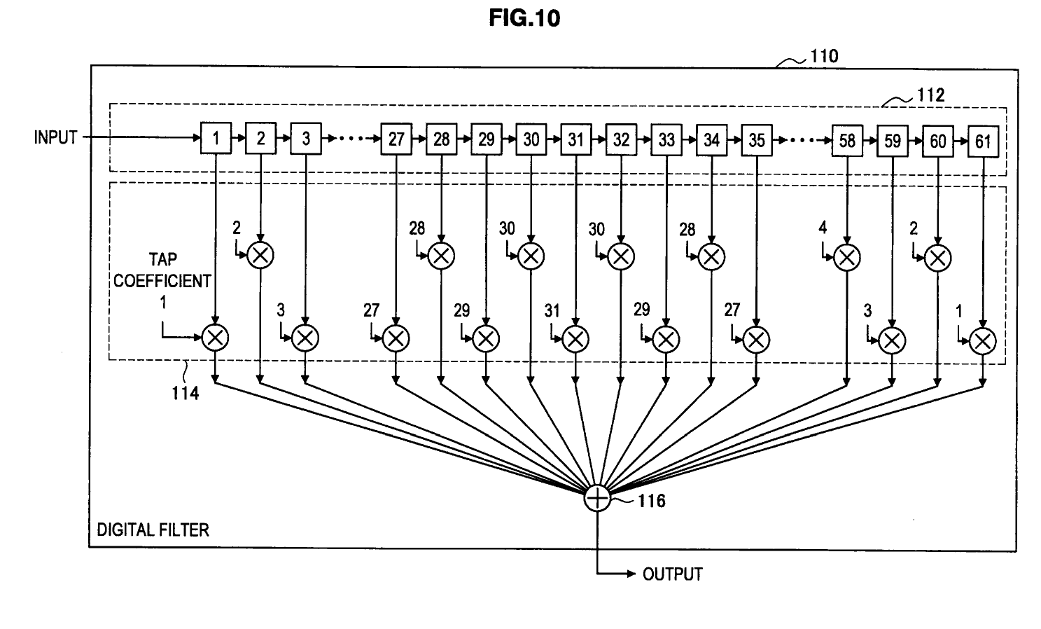

The digital filter 110 of the wireless communication apparatus 20 according to the embodiment is described hereinafter with reference to FIGS. 10 to 12. FIG. 10 is an explanatory view showing the structure of the digital filter 110. As shown in FIG. 10, the digital filter 110 is a FIR (Finite-duration Impulse Response) filter with a filter order of 60 and having 61 filter tap coefficients, and it includes a shift register 112, a multiplying unit 114 and a summing unit 116.

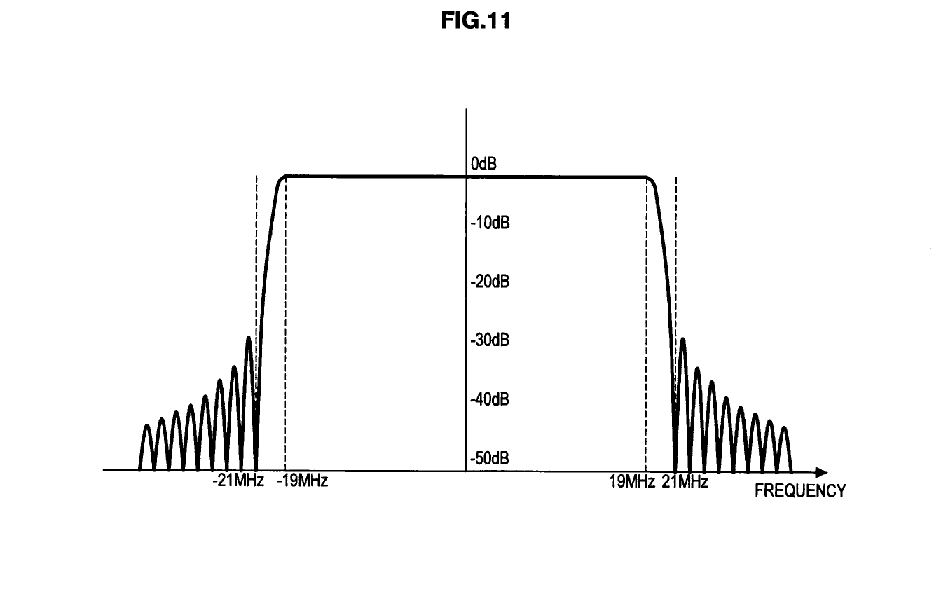

The signal selected by the selector 108 is input to the shift register 112. The shift register 112 includes 61 registers, and each register delays the input signal by one sample and transfers it to the register in the subsequent stage. The multiplying unit 114 multiplies the signal value held in each register included in the shift register 112 by a given filter tap coefficient. The frequency characteristics of the digital filter 110 depend on the filter tap coefficient. The summing unit 116 sums the signal values obtained by the multiplying unit 114 and outputs a result. The frequency characteristics of the digital filter 82 of the wireless communication apparatus 70 related to the embodiment are described hereinafter with reference to FIG. 11.

FIG. 11 is an explanatory view showing frequency characteristics of the digital filter 82 of the wireless communication apparatus 70 related to the embodiment. As shown in FIG. 11, the passband width of the digital filter 82 of the wireless communication apparatus 70 related to the embodiment is 38 MHz, and the frequency characteristics in the passband are substantially uniform. Further, it is designed that the gain of the signal components in unnecessary bands different from the passband drops sharply. Next, the frequency characteristics of the digital filter 110 of the wireless communication apparatus 20 according to the embodiment are described with reference to FIG. 12.

FIG. 12 is an explanatory view showing the frequency characteristics of the digital filter 110 of the wireless communication apparatus 20 according to the embodiment. As shown in FIG. 12, like the digital filter 82, the digital filter 110 of the wireless communication apparatus 20 according to the embodiment is also designed in such a way that the gain of the signal components in unnecessary bands different from the passband drops sharply. However, the function of the digital filter 110 of the wireless communication apparatus 20 according to the embodiment is largely different from that of the digital filter 82 in that the frequency characteristics in the passband are not uniform.

Specifically, the digital filter 110 according to the embodiment is designed in such a way that the gain in the vicinity of the shoulders of the passband becomes higher than the gain in the vicinity of the center of the passband in light of that the gain at the shoulders (in the vicinity of the ends) of the passband drops due to the aperture effect in the DAC 120. Such a design is implemented by appropriately selecting the filter tap coefficients in order to obtain the reverse characteristics of the aperture effect. An average gain in the digital filter 110 and the DAC 120 is thereby substantially 0 dB in the bandwidth, and the DAC 120 can thereby obtain the transmission signal having flat frequency characteristics in the passband.

As described above, in the wireless communication apparatus 20 according to the embodiment, the digital filter 110 can correct the aperture effect in addition to filtering out the signal components in unnecessary bands. It is thus not necessary for the wireless communication apparatus 20 according to the embodiment to include the aperture correction unit 76 as a separate and independent structure as in the wireless communication apparatus 70 related to the embodiment, thereby achieving reduction of the circuit size and power consumption.

### (4) Operation of the Wireless Communication Apparatus According to the Embodiment

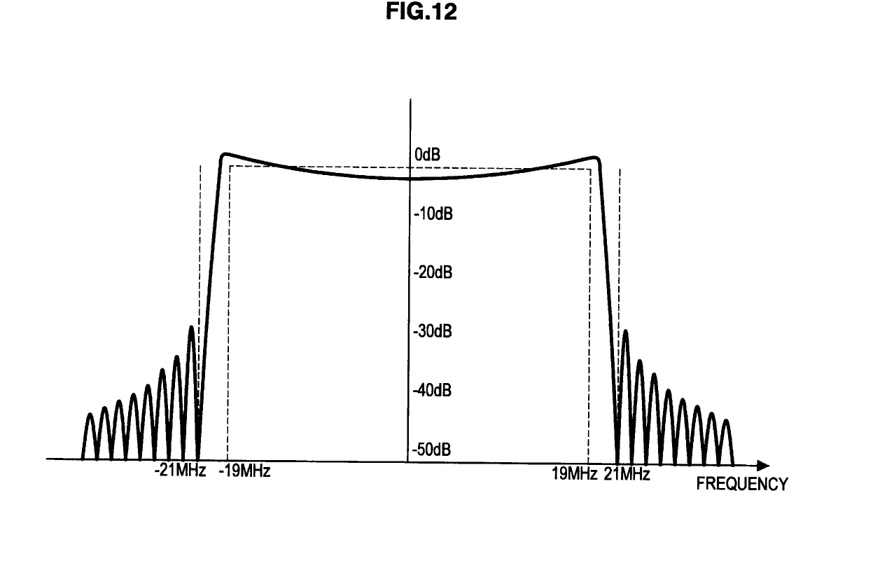

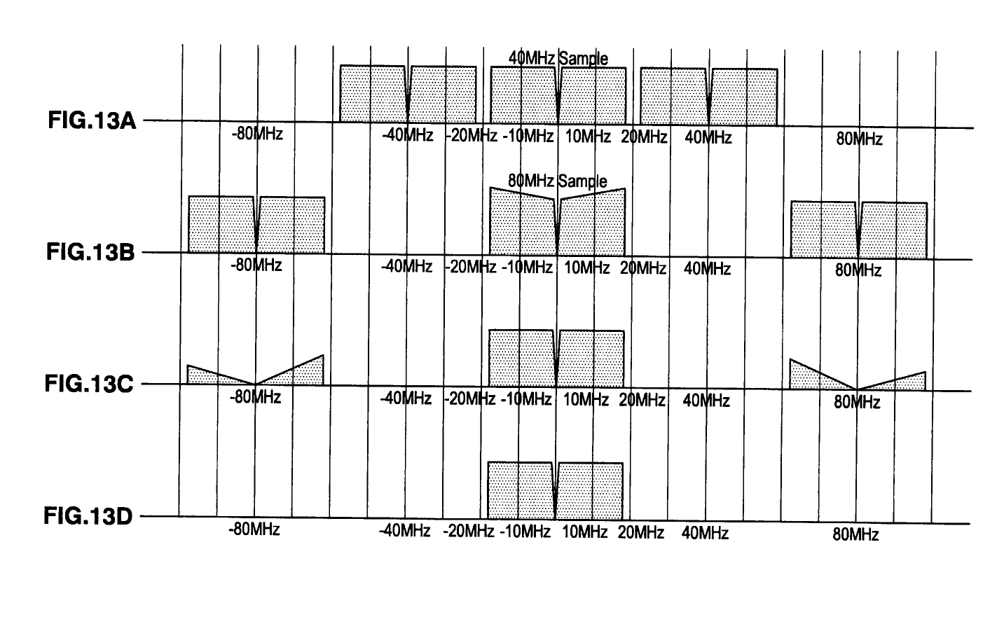

The function of the wireless communication apparatus 20 according to the embodiment is described above with reference to FIGS. 8 to 12. Hereinafter, the operation of the wireless communication apparatus 20 according to the embodiment is described with reference to FIGS. 13A to 13D.

FIG. 13A is an explanatory view showing frequency characteristics of a transmission signal input to the digital filter 110. As shown in FIG. 13A, the transmission signal when input to the digital filter 110 is sampled at 40 MHz and thus represented by the main lobe spectrum and the replicated side lobe spectrums centered at ±40 MHz. When the transmission signal shown in FIG. 13A is input, the digital filter 110 outputs a transmission signal having frequency characteristics shown in FIG. 13B.

FIG. 13B is an explanatory view showing frequency characteristics of a transmission signal that is output from the digital filter 110. As shown in FIG. 13B, zero-filling double oversampling is performed in the digital filter 110, and the signal components in unnecessary bands are removed. Further, because the transmission signal becomes sampling data of 80 MHz in the digital filter 110, the transmission signal is represented by the main lobe spectrum and the replicated side lobe spectrums centered at ±80 MHz. Further, because the aperture correction of the transmission signal is performed in the digital filter 110, the gain in the vicinity of the ±20 MHz of the main lobe spectrum is increased as shown in FIG. 13B. When the transmission signal shown in FIG. 13B is input to the DAC 120, the DAC 120 outputs a transmission signal having frequency characteristics shown in FIG. 13C.

FIG. 13C is an explanatory view showing frequency characteristics of a transmission signal that is output from the DAC 120. As shown in FIG. 13C, the transmission signal that is converted into an analog format in the DAC 120 has flat frequency characteristics in the passband as a result that the gain at the shoulders of the main lobe spectrum shown in FIG. 13B is reduced by the aperture effect. Further, the characteristics of the side lobe spectrums centered at ±80 MHz are largely distorted by the aperture effect. When the transmission signal shown in FIG. 13C is input to the RF transmission processing unit 122, the RF transmission processing unit 122 generates a transmission signal having frequency characteristics shown in FIG. 13D.

FIG. 13D is an explanatory view showing frequency characteristics of a transmission signal generated in the RF transmission processing unit 122. As shown in FIG. 13D, when the transmission signal shown in FIG. 13C is input, the RF transmission processing unit 122 removes the side lobe spectrums centered at ±80 MHz by means of an analog filter and thereby obtains a desired transmission signal.

### (5) Summary

As described above, according to the embodiment, the digital filter 110 can correct the aperture effect in addition to filtering out the signal components in unnecessary bands. Therefore, in this embodiment, it is not necessary for the wireless communication apparatus 20 to include a structure for performing aperture correction as an independent unit, and it is thereby possible to reduce the circuit size and power consumption. Further, because the digital filter 110 has the aperture correction function, it is not necessary that the aperture correction is made on the L-STF and the L-LTF stored in the preamble table 126. Therefore, even if the degree of aperture effect changes due to a change in specifications of the DAC 120 or the like, it is not necessary to recalculate the L-STF and the L-LTF stored in the preamble table 126. The wireless communication apparatus 20 according to the embodiment can thereby improve the flexibility of a change in specifications.

It should be understood by those skilled in the art that various modifications, combinations, sub-combinations and alterations may occur depending on design requirements and other factors insofar as they are within the scope of the appended claims or the equivalents thereof.

For example, although an example where the digital filter 110 is configured using a FIR filter is described in the above embodiment, the present invention is not limited thereto. As an alternative example, the digital filter 110 may be configured using an IIR (Infinite-duration Impulse Response) filter. Further, although an example where the aperture effect occurring in the DAC 120 is corrected is described in the above embodiment, the present invention is not limited thereto. For example, if the wireless communication apparatus 20 includes a structure different from the DAC 120 that has the hold function for outputting a rectangular waveform, the aperture effect occurring in such a structure may be corrected in the same manner.

The present application contains subject matter related to that disclosed in Japanese Priority Patent Application JP 2008-195226 filed in the Japan Patent Office on Jul. 29, 2008, the entire content of which is hereby incorporated by reference.

What is claimed is:

1. A transmitting apparatus comprising:
a signal processing unit to perform signal processing of transmission data; and
an antenna to transmit transmission data processed by the signal processing unit, wherein
the signal processing unit includes a digital filter to extract a signal component in a given frequency band and correct an aperture effect occurring during the signal processing.

2. The transmitting apparatus according to claim 1, wherein
the signal processing unit further includes
a digital modulation unit to convert the transmission data into a digital modulation signal, and
a DA conversion unit to convert the digital modulation signal into an analog format, and
the digital filter corrects an aperture effect occurring in the DA conversion unit.

3. The transmitting apparatus according to claim 2, wherein
the signal processing unit further includes
a storage unit to store a synchronous training signal to be added to the transmission data, and
a selection unit to select one of the digital modulation signal and the synchronous training signal, and
one of the digital modulation signal and the synchronous training signal selected by the selection unit is input to the digital filter.

4. A signal processing method comprising the steps of:
performing signal processing of transmission data; and
transmitting processed transmission data, wherein
the step of performing signal processing extracts a signal component in a given frequency band and corrects an aperture effect occurring during the step of performing signal processing with use of a digital filter.

5. A communication system comprising:
a transmitting apparatus including
a signal processing unit to perform signal processing of transmission data, and
an antenna to transmit transmission data processed by the signal processing unit; and
a receiving apparatus to receive the transmission data transmitted from the transmitting apparatus, wherein
the signal processing unit of the transmitting apparatus includes a digital filter to extract a signal component in a given frequency band and correct an aperture effect occurring during the signal processing.
